(19) United States
(12) Patent Application Publication
(10) Pub. No.: US 2025/0171093 A1
(43) Pub. Date: May 29, 2025

(54) VEHICLE AIR SKIRT APPARATUS

(71) Applicant: HYUNDAI MOBIS CO., LTD., Seoul (KR)

(72) Inventors: Jae Sup BYUN, Yongin-si (KR); Jang Ho KIM, Yongin-si (KR)

(73) Assignee: HYUNDAI MOBIS CO., LTD., Seoul (KR)

(21) Appl. No.: 18/674,241

(22) Filed: May 24, 2024

(30) Foreign Application Priority Data
Nov. 24, 2023 (KR) 10-2023-0165648

(51) Int. Cl. B62D 35/00

(52) U.S. Cl. CPC B62D 35/005

(57) ABSTRACT

The present invention relates to a vehicle air skirt apparatus improved to prevent generation of a gap between a second skirt and a control unit after the second skirt is rotated. The vehicle air skirt apparatus includes a housing unit in which a withdrawal hole is formed, a skirt unit including a first skirt which is movably disposed in the housing unit and allowed to protrude outward from the housing unit through the withdrawal hole and a second skirt which is rotatable to be tilted after the first skirt is completely withdrawn, and a support unit which moves in the same direction as a moving direction of the first skirt and rotatably supports the second skirt tilted after the first skirt is completely withdrawn.

### CROSS-REFERENCE TO RELATED APPLICATION

This application claims priority to and the benefit of Korean Patent Application No. 10-2023-0165648, filed on 24 Nov. 2023, the disclosure of which is incorporated herein by reference in its entirety.

### BACKGROUND

### 1. Field of the Invention

The present invention relates to a vehicle air skirt apparatus.

### 2. Discussion of Related Art

When a vehicle travels, a vehicle body collides with a headwind which is air in an atmosphere, and thus an air resistance force is applied to the vehicle, and in this case, the resistance force of the headwind causes a decrease in fuel efficiency. Accordingly, a structure for improving aerodynamic performance and increasing the fuel efficiency by reducing the resistance force of the headwind is required in the vehicle.

One example of an apparatus for improving aerodynamic performance includes an air skirt apparatus which is disposed at a front side of the vehicle and reduces an amount of air being introduced into an underbody through a front bumper when the vehicle travels at a high speed and thus improves the aerodynamic performance. Such an air skirt apparatus may include a first skirt protruding outward from a vehicle, a second skirt disposed below the first skirt and rotated to be tilted after protruding along with the first skirt, a rotary shaft which is connected to the second skirt and rotates the second skirt, and a control unit which is connected to the rotary shaft and provides power to the rotary shaft to rotate the rotary shaft.

However, the conventional air skirt apparatus has a problem that, after the second skirt is rotated, the second skirt is shaken by the headwind due to a gap formed between the second skirt and the control unit due to an unstable structure for fixing the second skirt. Accordingly, there is a problem of degrading the headwind blocking performance of the second skirt. In addition, since the second skirt is shaken, there are problems of damaging the second skirt and degrading durability.

### SUMMARY OF THE INVENTION

The present invention is directed to providing a vehicle air skirt apparatus improved to prevent the formation of a gap between a second skirt and a control unit after the second skirt rotates.

According to an aspect of the present invention, there is a vehicle air skirt apparatus including a housing unit in which a withdrawal hole is formed, a skirt unit including a first skirt which is movably disposed in the housing unit and allowed to protrude outward from the housing unit through the withdrawal hole and a second skirt which is rotatable to be tilted after the first skirt is completely withdrawn, and a support unit configured to move in the same direction as a moving direction of the first skirt and rotatably support the second skirt tilted after the first skirt is completely withdrawn.

The vehicle air skirt apparatus may include a slide cover fixedly installed on the first skirt, wherein the support unit may be slidably disposed on the slide cover.

The vehicle air skirt apparatus may include a link unit configured to be connected to the support unit and move the support unit, wherein the support unit may include a first support block connected to the link unit and a second support block connected to the first support block and movably disposed on the slide cover.

The second support block of the support unit may include a first moving part disposed inside the slide cover, a second moving part disposed on an end portion of the first moving part and disposed outside the slide cover, and a support protrusion configured to be disposed on the second moving part and movably supports the second skirt.

The second moving part of the second support block may be disposed to be inclined with respect to the first moving part.

The second skirt may include a skirt body, a center rib configured to support the skirt body, a side rib disposed outside the center rib and configured to support the skirt body, and a slit hole formed in the center rib and configured to accommodate the support protrusion of the second moving part of the support unit therein.

The slit hole of the second skirt may include a first region configured to come into contact with the support protrusion before the second skirt is tilted and a second region configured to come into contact with the support protrusion after the second skirt is tilted.

The vehicle air skirt apparatus may include a stopper rotatably coupled to the slide cover in place and configured to come into contact with the first moving part of the second support block of the support unit.

The stopper may be pressed by the second support block of the support unit that moves in conjunction with movement of the link unit to activate a moving path of the first moving part.

The vehicle air skirt apparatus may include a side plate fixedly installed on the first skirt and configured to provide a protrusion as a rotation center of the second skirt, wherein the rotation center of the second skirt may be collinearly disposed with the support protrusion of the second support block in a direction from the first support block of the support unit toward the second support block.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a vehicle air skirt apparatus according to one embodiment of the present invention;

FIG. 2 is an exploded perspective view illustrating the vehicle air skirt apparatus according to one embodiment of the present invention;

FIG. 3 is a view illustrating a withdrawal hole formed in a housing unit;

FIG. 4 is a view illustrating a second skirt;

FIG. 5 is a view illustrating a state in which an operation control unit is coupled to a first skirt and the second skirt;

FIG. 6A is a view illustrating a state in which a slide cover is coupled to the first skirt;

FIG. 6B is a view illustrating a state in which a first support block is disposed on the slide cover;

FIG. 7 is an exploded perspective view illustrating a support unit;

FIG. 8 is a cross-sectional view illustrating the first skirt, the slide cover, the support unit, and an auxiliary plate;

FIG. 9 is a cross-sectional view illustrating a state in which a support protrusion of a second support block is disposed in a slit hole of the second skirt;

FIG. 10 is a cross-sectional view illustrating a state in which a stopper is coupled to the slide cover and a second auxiliary plate;

FIG. 11 is a view illustrating the second support block and the stopper in a first state;

FIG. 12 is a view illustrating the second support block and the stopper in a second state;

FIG. 13 is a view illustrating the second support block and the stopper in a third state;

FIG. 14 is a view illustrating a state in which a side plate and a rail block are disposed;

FIG. 15 is a view illustrating a state in which a connecting bracket connects the second skirt and the side plate;

FIG. 16A shows the first state of the vehicle air skirt apparatus according to one embodiment of the present invention;

FIG. 16B shows the second state of the vehicle air skirt apparatus according to one embodiment of the present invention;

FIG. 16C shows the third state of the vehicle air skirt apparatus according to one embodiment of the present invention;

FIG. 17A shows shapes of states in which the support protrusion of the second support block of the support unit is in contact with a first region of a first slit hole of the second skirt;

FIG. 17B shows shapes of states in which the support protrusion of the second support block of the support unit is in contact with a second region of a first slit hole of the second skirt; and

FIG. 18 is a view illustrating an arrangement relationship between the support protrusion of the second support block of the support unit and a central protrusion of the side plate.

### DETAILED DESCRIPTION OF EXEMPLARY EMBODIMENTS

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination of a plurality of associated listed items.

When a first element is referred to as being “connected” or “coupled” to a second element, it should be understood that the first element may be directly connected or coupled to the second element, or a third element may be present therebetween. In contrast, when a first element is referred to as being “directly connected” or “directly coupled” to a second element, it will be understood that there are no intervening elements.

In a description of the embodiment, in a case in which any first element is described as being formed on or under a second element, such a description includes both a case in which the two elements are formed in direct contact with each other and a case in which the two elements are in indirect contact with each other with one or more third elements interposed between the two elements. In addition, when a first element is described as being formed on or under a second element, such a description may include a case in which the first element is formed at an upper side or a lower side with respect to the second element.

Terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” used herein specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, a vehicle air skirt apparatus will be described in detail with reference to the accompanying drawings, and components that are the same or correspond to each other will be denoted by the same reference numerals, and redundant descriptions thereof will be omitted.

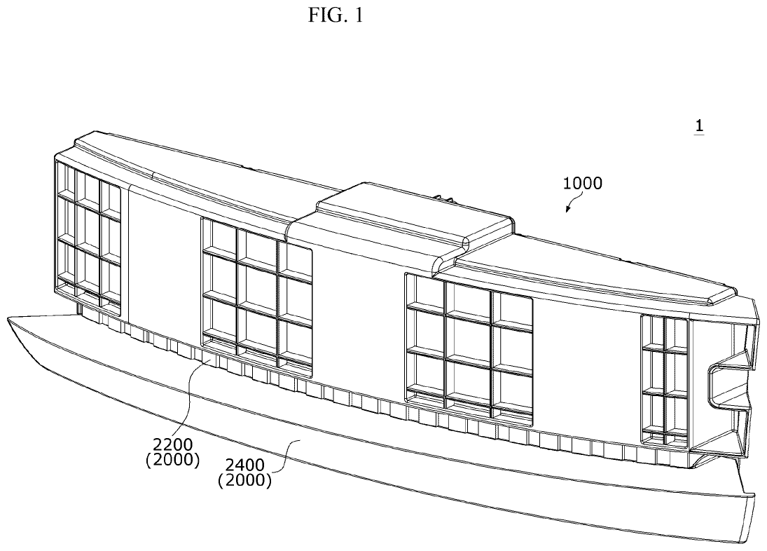

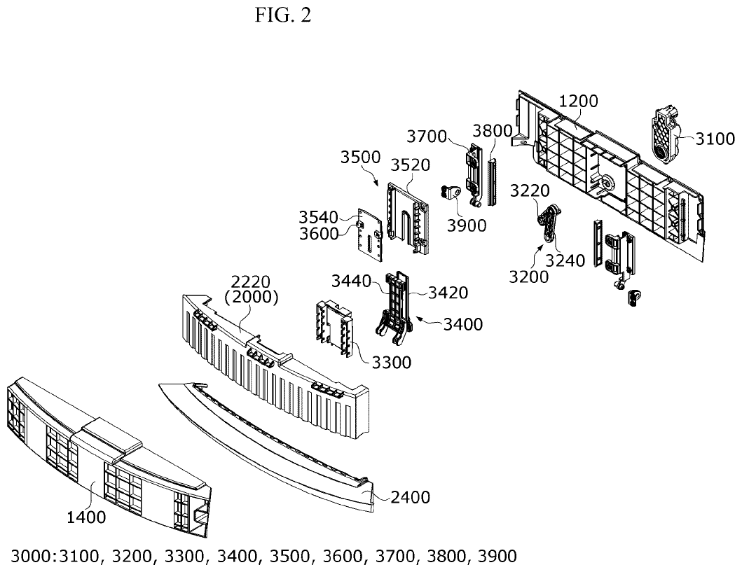

FIG. 1 is a perspective view illustrating a vehicle air skirt apparatus according to one embodiment of the present invention, and FIG. 2 is an exploded perspective view illustrating the vehicle air skirt apparatus according to one embodiment of the present invention.

Referring to FIGS. 1 and 2, a vehicle air skirt apparatus 1 according to one embodiment of the present invention may be disposed on a front portion of the vehicle in a longitudinal direction. The vehicle air skirt apparatus 1 may allow a headwind, which is generated when the vehicle travels, to be introduced into the vehicle or block the headwind depending on the passenger's choice. The vehicle air skirt apparatus 1 may include a housing unit 1000, a skirt unit 2000, and an operation control unit 3000.

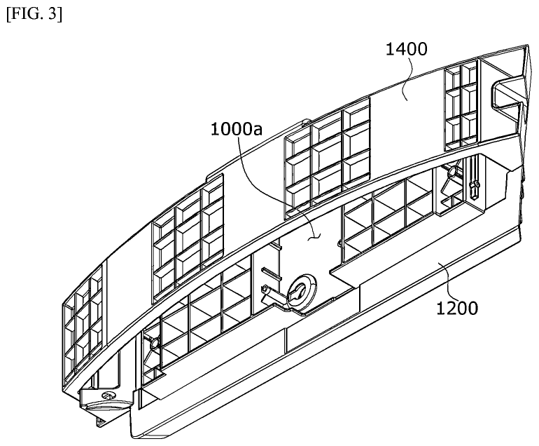

FIG. 3 is a view illustrating a withdrawal hole formed in the housing unit.

Referring to FIGS. 1 to 3, the housing unit 1000 may accommodate a portion of the skirt unit 2000 therein to guide movement of the skirt unit 2000 and may be coupled to the operation control unit 3000 to support the operation control unit 3000. The housing unit 1000 may include a first housing 1200 and a second housing 1400.

The first housing 1200 may support some components of the operation control unit 3000 other than an actuator 3100 which will be described below. The first housing 1200 may support the actuator 3100 which will be described below. In this case, the actuator 3100 may be disposed outside the first housing 1200.

The second housing 1400 may be disposed in front of the first housing 1200 in the longitudinal direction. In this case, the longitudinal direction may have the same meaning as a direction from a passenger's room (not shown) toward an engine room (not shown) of the vehicle. The second housing 1400 may be coupled to the first housing 1200 and supported by the first housing 1200. The second housing 1400 may cover a region in the front of the first housing 1200 in the longitudinal direction.

As illustrated in FIG. 3, a withdrawal hole 1000a may be formed in the housing unit 1000. More specifically, the withdrawal hole 1000a may be formed by closing one open side of the second housing 1400 using the first housing 1200. The withdrawal hole 1000a formed in the housing unit 1000 may be a region which allows a portion of the skirt unit 2000 and a portion of the operation control unit 3000 disposed in the housing unit 1000 to move.

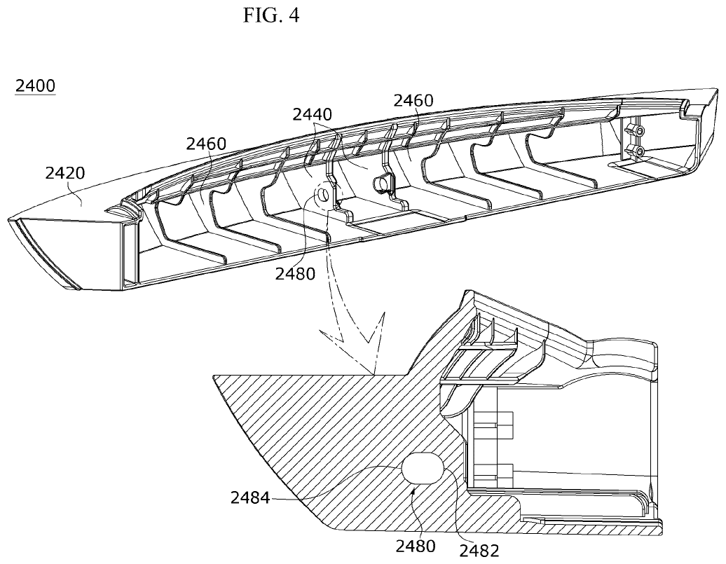

FIG. 4 is a view illustrating the second skirt.

Referring to FIGS. 1, 2, and 4, the skirt unit 2000 may include a first skirt 2200 which is movably disposed in the housing unit 1000 and may protrude outward from the housing unit 1000 through the withdrawal hole 1000a and a second skirt 2400 which may rotate to be tilted after the withdrawal of the first skirt 2200 is completed. As illustrated in FIG. 1, the first skirt 2200 may move toward the outside of the housing unit 1000 by the operation control unit 3000 in a state of being disposed in the housing unit 1000. In this case, the first skirt 2200 may move in a height direction. In this case, the height direction may be a direction perpendicularly intersecting the longitudinal direction. The first skirt 2200 may include a skirt body.

The skirt body (hereinafter, referred to as a “first skirt body 2220”) may be a thin hollow frame. The first skirt body 2220 may move to protrude outward from the housing unit 1000 through the withdrawal hole 1000a in the height direction. Accordingly, the first skirt 2200 may block a headwind.

The second skirt 2400 may be coupled to the first skirt 2200. More specifically, although the second skirt 2400 maintains a state of being in contact with the first skirt 2200, the second skirt 2400 may not be fixed to the first skirt 2200 and may be rotated to be tilted with respect to the first skirt 2200 by the operation control unit 3000. The second skirt 2400 may include a skirt body, a center rib 2440, a side rib 2460, and a slit hole.

The skirt body (hereinafter, referred to as a “second skirt body 2420”) may be a thin hollow frame. The second skirt body 2420 maintains a state of being in contact with the first skirt body 2220. The second skirt body 2420 may be connected to a side plate 3700, which will be described below, by a connecting bracket 3900 which will be described below. Accordingly, the second skirt body 2420 may not be separated from the first skirt 2200.

The center rib 2440 may be disposed on a surface of the second skirt body 2420 which is not externally exposed. The center rib 2440 may be provided as a plurality of center ribs 2440. The side rib 2460 may be disposed outside the center rib 2440 in a width direction. In this case, the width direction may be a direction intersecting the longitudinal direction. The side rib 2460 may be provided as a plurality of side ribs 2460. The center rib 2440 and the side rib 2460 may support the second skirt 2400 to reinforce the strength of the second skirt 2400.

As illustrated in FIG. 4, the slit hole (hereinafter, referred to as a “first slit hole 2480”) may be formed in the center rib 2440. The first slit hole 2480 may be disposed in the center rib 2440 in the longitudinal direction. The first slit hole 2480 may have a long hole shape. The first slit hole 2480 may accommodate a support protrusion 3443 of a second support block 3440 of a support unit 3400, which will be described below, therein. The first slit hole 2480 may include a first region 2482 which comes into contact with the support protrusion 3443 of the second support block 3440 before the second skirt 2400 is tilted and a second region 2484 which comes into contact with the support protrusion 3443 of the second support block 3440 after the second skirt 2400 is tilted.

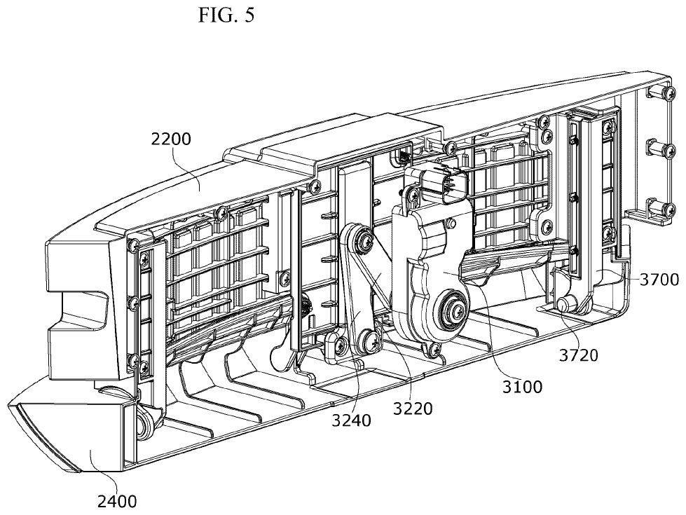

FIG. 5 is a view illustrating a state in which the operation control unit is coupled to the first skirt and the second skirt;

The operation control unit 3000 may be connected to the housing unit 1000 and the skirt unit 2000 and control the operation of the first skirt 2200 and the second skirt 2400. The operation control unit 3000 may include the actuator 3100, a link unit 3200, a slide cover 3300, the support unit 3400, an auxiliary plate 3500, a stopper 3600, the side plate 3700, a rail block 3800, and the connecting bracket 3900.

Referring to FIGS. 2 and 5, the actuator 3100 may be coupled to the first housing 1200 of the housing unit 1000. In this case, the actuator 3100 may be disposed outside the first housing 1200. The actuator 3100 may be connected to an external power supply apparatus (not shown) and generate power. In addition, the actuator 3100 may be connected to the link unit 3200. Accordingly, the actuator 3100 may rotate the link unit 3200.

The link unit 3200 may be disposed in the housing unit 1000. The link unit 3200 may be rotated by the power generated by the actuator 3100 and connected to the support unit 3400 to move the support unit 3400. The link unit 3200 may include a first link 3220 coupled to the actuator 3100 and a second link 3240 rotatably coupled to the first link 3220 and coupled to the support unit 3400.

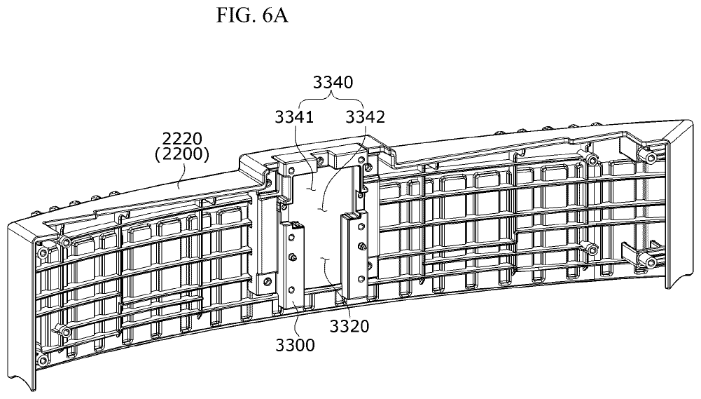

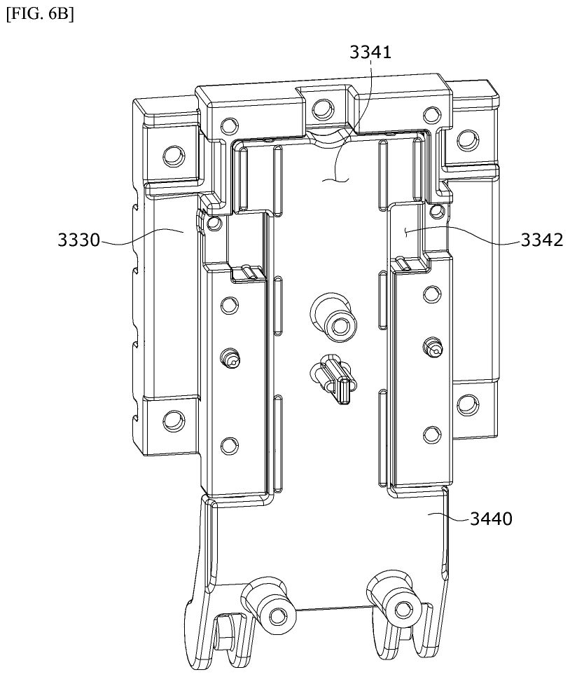

FIG. 6A is a view illustrating a state in which the slide cover is coupled to the first skirt, and FIG. 6B is a view illustrating a state in which a first support block is disposed in the slide cover.

Referring to FIGS. 2, 5, 6A, and 6B, the slide cover 3300 may be disposed in the housing unit 1000. Particularly, as illustrated in FIG. 6A, the slide cover 3300 may be fixedly installed in the first skirt 2200. The slide cover 3300 may movably accommodate a portion of the support unit 3400. The slide cover 3300 may move outward or inward from the housing unit 1000 along with the first skirt 2200.

As illustrated in FIG. 6B, the slide cover 3300 may include a second slit hole 3320 and a third slit hole 3340 which accommodate a first moving part 3441 of the second support block 3440, which will be described below, of the support unit 3400. Particularly, the third slit hole 3340 may be formed to have a greater length than a portion of the first moving part 3441 of the second support block 3440. In this case, the third slit hole 3340 may include a third region 3341 in which a state in which the first moving part 3441 is disposed is maintained before a first support block 3420 is moved and a fourth region 3342 in which the first support block 3420 is moved and the first moving part 3441 is disposed.

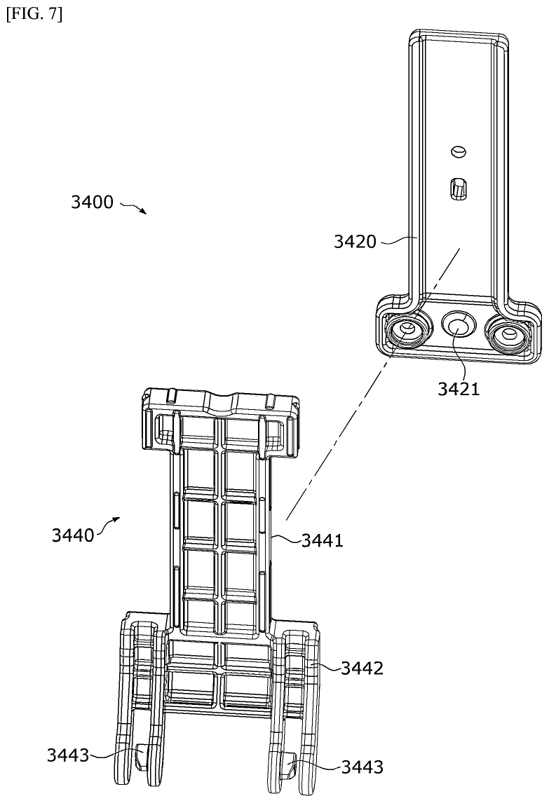

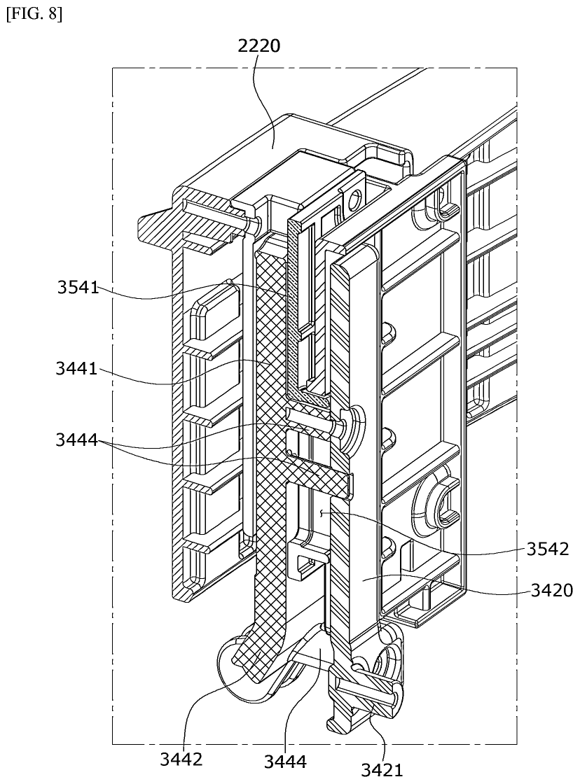

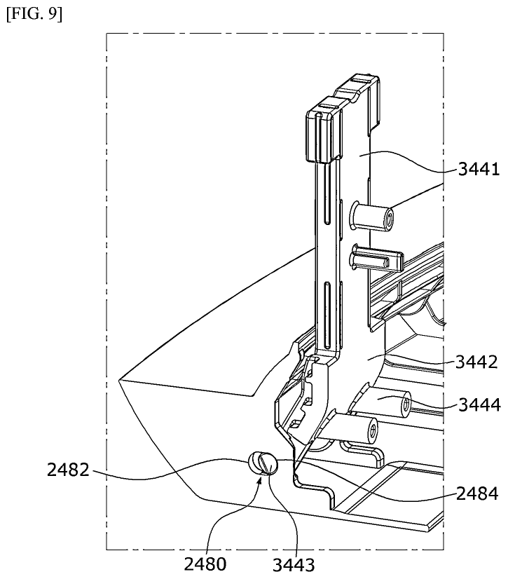

FIG. 7 is an exploded perspective view illustrating the support unit, FIG. 8 is a cross-sectional view illustrating the first skirt, the slide cover, the support unit, and the auxiliary plate, and FIG. 9 is a cross-sectional view illustrating a state in which the support protrusion of the second support block is disposed in the slit hole of the second skirt;

Referring to FIGS. 2 and 7 to 9, the support unit 3400 may be disposed in the housing unit 1000. Particularly, the support unit 3400 may be disposed between the first housing 1200 of the housing unit 1000 and the first skirt 2200. The support unit 3400 may move in the same direction as a moving direction of the first skirt 2200 and rotatably support the second skirt 2400 which is tilted after the withdrawal of the first skirt 2200 is completed. The support unit 3400 may include the first support block 3420 and the second support block 3440.

As illustrated in FIGS. 5 and 8, the first support block 3420 may be connected to the link unit 3200. In addition, the first support block 3420 may be slidably coupled to a first auxiliary plate 3520, which will be described below, of the auxiliary plate 3500.

The first support block 3420 may include a first coupling protrusion 3421. The first coupling protrusion 3421 may be coupled to the second link 3240. Accordingly, the first support block 3420 may be moved upward or downward in the height direction by the first coupling protrusion 3421 being moved along the second link 3240.

The second support block 3440 may be coupled to the first support block 3420. The second support block 3440 may be movably disposed on the slide cover 3300. The second support block 3440 may include the first moving part 3441, a second moving part 3442, the support protrusion 3443, and a second coupling protrusion 3444.

The first moving part 3441 may be disposed inside the slide cover 3300. The first moving part 3441 may move along with the slide cover 3300 in the height direction by the first support block 3420 or may slidably move from the slide cover 3300.

As illustrated in FIGS. 5 and 9, the second moving part 3442 may be disposed on an end portion of the first moving part 3441. The second moving part 3442 may be disposed outside the slide cover 3300. The second moving part 3442 may move along with the first moving part 3441 in the height direction. In addition, the second moving part 3442 may have a greater width than the first moving part 3441 in the width direction. Accordingly, when the second moving part 3442 moves in the height direction, the second moving part 3442 comes into contact with the slide cover 3300 to block further movement of the second support block 3440.

As illustrated in FIG. 9, the support protrusion 3443 may be disposed on the second moving part 3442. The support protrusion 3443 may be provided as a plurality of support protrusions 3443. The plurality of support protrusions 3443 may have shapes protruding toward each other. The support protrusion 3443 may be accommodated in the first slit hole of the second skirt 2400. The support protrusion 3443 may movably support the second skirt 2400. The support protrusion 3443 may support the tilted second skirt 2400 in a state of being accommodated in the first slit hole. This is for the support protrusion 3443 to block further rotation of the second skirt 2400 so as to secure an additional headwind blocking region as much as an extent intended in a process of manufacturing the second skirt 2400. In addition, the reason why the support protrusion 3443 supports the second skirt 2400 is for blocking excessive rotation of the second skirt 2400 so as to prevent the formation of a gap between the first skirt 2200 and the second skirt 2400.

As illustrated in FIG. 8, the second coupling protrusion 3444 may be formed on each of the first moving part 3441 and the second moving part 3442. The second coupling protrusion 3444 may protrude from a surface, which does not face the first skirt 2200 and the second skirt 2400, among the surfaces of the first moving part 3441 and the second moving part 3442. The second coupling protrusion 3444 may be coupled to the first support block 3420. The second support block 3440 may be moved in the height direction in conjunction with movement of the first support block 3420 by the second coupling protrusion 3444.

As described above, the support unit 3400 may be slidably disposed on the slide cover 3300 and control movement of the second skirt 2400 so that the second skirt 2400 moves independently of the first skirt 2200. Accordingly, since the necessity of a separate power apparatus for tilting the second skirt 2400 is eliminated due to the support unit 3400, the support unit can reduce a manufacturing cost of the vehicle air skirt apparatus.

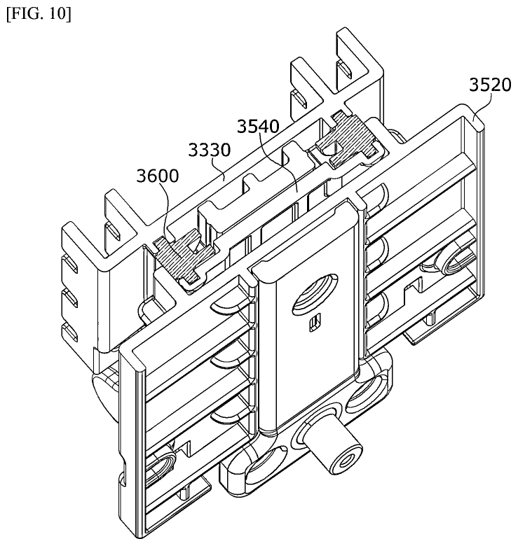

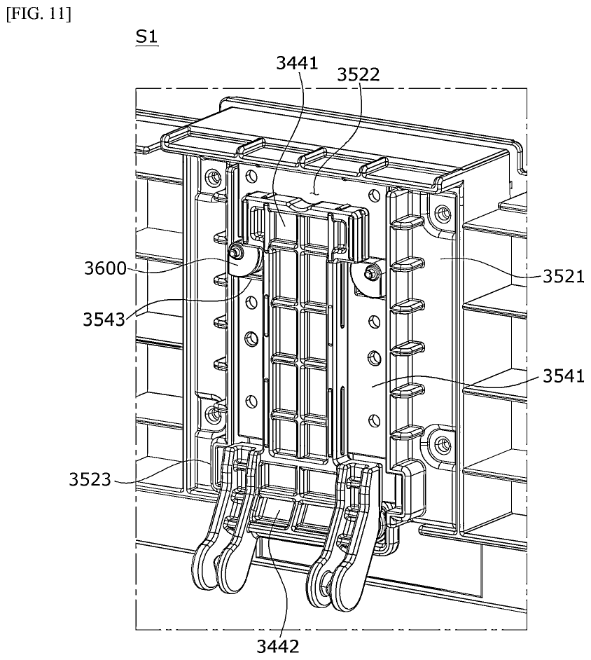

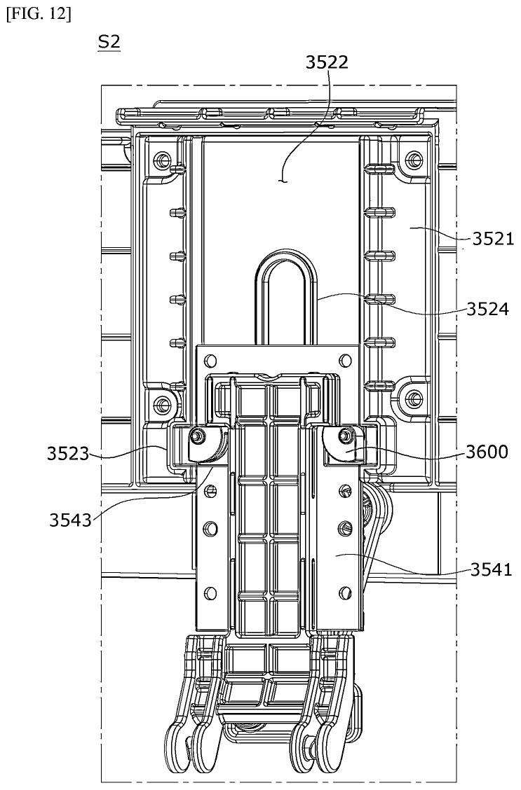

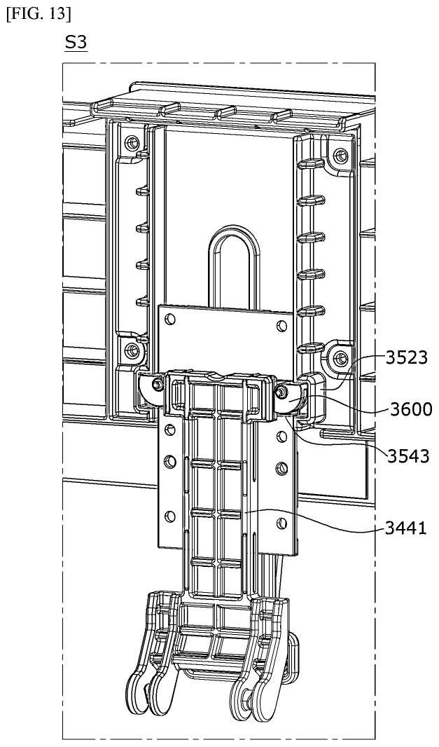

FIG. 10 is a cross-sectional view illustrating a state in which the stopper is coupled to the slide cover and a second auxiliary plate, and FIG. 11 is a view illustrating the second support block and the stopper in a first state. FIG. 12 is a view illustrating the second support block and the stopper in a second state, and FIG. 13 is a view illustrating the second support block and the stopper in a third state.

Referring to FIGS. 2, 5, 8, and 10 to 13, the auxiliary plate 3500 may assist movement of the support unit 3400. The auxiliary plate 3500 may include the first auxiliary plate 3520 and a second auxiliary plate 3540.

As illustrated in FIGS. 8 and 10 to 13, the first auxiliary plate 3520 may include a first plate body 3521, a first accommodation groove 3522, a second accommodation groove 3523, and a third accommodation groove 3524.

The first plate body 3521 may be fixedly installed in the first housing 1200 of the housing unit 1000. The first plate body 3521 may be formed of a combination of a rectangular panel and a protrusion protruding outward from one surface of the panel toward the skirt unit 2000.

The first accommodation groove 3522 may be formed inside the protrusion constituting the first plate body 3521. The first accommodation groove 3522 may accommodate the second auxiliary plate 3540 therein. The second accommodation groove 3523 may be formed in an end portion region of the first plate body 3521. The second accommodation groove 3523 may be formed in a portion in which a portion of the protrusion forming the first plate body 3521 is bent. The second accommodation groove 3523 may communicate with a fourth accommodation groove 3543, which will be described below, of the second auxiliary plate 3540. The second accommodation groove 3523 may rotatably accommodate a portion of the stopper 3600 that moves downward in the height direction. The third accommodation groove 3524 may be formed in a central region of the first accommodation groove 3522. As illustrated in FIGS. 8, 12, and 13, the third accommodation groove 3524 may form a space in which a portion of the second auxiliary plate 3540 may move.

The second auxiliary plate 3540 may be coupled to the first auxiliary plate 3520. The second auxiliary plate 3540 may include a second plate body 3541, an accommodation hole 3542, and the fourth accommodation groove 3543.

The second plate body 3541 may be slidably disposed in the first accommodation groove 3522 of the first auxiliary plate 3520. The second plate body 3541 may be formed of a combination of a rectangular panel and a protrusion protruding outward from one surface of the panel toward the skirt unit 2000.

The accommodation hole 3542 may be formed inside the protrusion forming the second plate body 3541. As illustrated in FIG. 8, the accommodation hole 3542 may movably accommodate the second coupling protrusion 3444 of the second support block 3440 of the support unit 3400 therein. Accordingly, the second support block 3440 of the support unit 3400 may secure an additional movement distance in the height direction.

As illustrated in FIGS. 11 to 13, the fourth accommodation groove 3543 may rotatably accommodate the stopper 3600 therein. The fourth accommodation groove 3543 may be disposed in an end portion of the second plate body 3541 in the width direction. When the second plate body 3541 is disposed in the first accommodation groove 3522 of the first auxiliary plate 3520, open one side of the fourth accommodation groove 3543 may be closed by the protrusion forming the first plate body 3521. When the second plate body 3541 moves in the height direction, the fourth accommodation groove 3543 may be disposed at a position at which the fourth accommodation groove 3543 communicates with the second accommodation groove 3523 of the first auxiliary plate 3520. Accordingly, the fourth accommodation groove 3543 may communicate with the second accommodation groove 3523.

As illustrated in FIGS. 2, 10, and 11 to 13, the stopper 3600 may be rotatably coupled to the slide cover 3300 in place to come into contact with the first moving part 3441 of the second support block 3440 of the support unit 3400. More specifically, as illustrated in FIG. 10, the stopper 3600 may be rotatably coupled to the slide cover 3300 and the second plate body 3541 of the second auxiliary plate 3540. In this state, the stopper 3600 may be rotatably disposed in the fourth accommodation groove 3543 of the second auxiliary plate 3540. The stopper 3600 may have a fan-shaped cross section. While the stopper 3600 is disposed in the fourth accommodation groove 3543, a state in which rotation is blocked by the protrusion forming the first plate body 3521 of the first auxiliary plate 3520 may be maintained.

As illustrated in FIGS. 11 to 13, the stopper 3600 may be pressed by the second support block 3440 of the support unit 3400 that moves in conjunction with movement of the link unit 3200 to activate a moving path of the first moving part 3441.

More specifically, as illustrated in FIGS. 1 and 11, in a first state S1 of the vehicle air skirt apparatus 1 in which the first skirt 2200 is not withdrawn to the outside of the housing unit 1000, the stopper 3600 maintains a state of being accommodated in the fourth accommodation groove 3543 of the second auxiliary plate 3540, and a state in which rotation is blocked by the protrusion forming the first plate body 3521 of the first auxiliary plate 3520 is maintained.

In this state, when the support unit 3400 is moved downward in the height direction by the link unit 3200 like a process from FIG. 11 to FIG. 12, particularly, the first moving part 3441 of the second support block 3440 of the support unit 3400 is moved downward in the height direction, the stopper 3600 is pressed by the first moving part 3441 of the second support block 3440 and moved downward along with the second auxiliary plate 3540 in the height direction. In this state, a state in which the moving path of the first moving part 3441 is not activated yet is maintained.

As described above, when the stopper 3600 moves along with the second moving part 3442 of the support unit 3400 and the second auxiliary plate 3540, the vehicle air skirt apparatus 1 may enter a second state S2 in which the second skirt 2400 moves to be withdrawn to the outside of the housing unit 1000. In the second state S2 of the vehicle air skirt apparatus 1, the fourth accommodation groove 3543 of the second auxiliary plate 3540 may be disposed at a position at which the fourth accommodation groove 3543 communicates with the second accommodation groove 3523 of the first auxiliary plate 3520. Accordingly, the stopper 3600 may enter a rotatable state.

In this state, since the support unit 3400 is continuously moved downward in the height direction through the link unit 3200 rotated by power generated by the actuator 3100, the first moving part 3441 of the support unit 3400 maintains a state of continuously pressing the stopper 3600. In this case, since the fourth accommodation groove 3543 of the second auxiliary plate 3540 is in a state of communicating with the second accommodation groove 3523 of the first auxiliary plate 3520, the stopper 3600 may be rotated in place and disposed in the second accommodation groove 3523 of the first auxiliary plate 3520 like a process from FIG. 12 to FIG. 13. Accordingly, the moving path of the first moving part 3441 may be activated.

As described above, the stopper 3600 may activate or close a moving path of the second support block 3440 according to positions at which the support unit 3400 and the second auxiliary plate 3540 move. Accordingly, the stopper 3600 may block unwanted movement of the support unit 3400 to prevent unintended movement (rotation) of the second skirt 2400 in a manufacturing process.

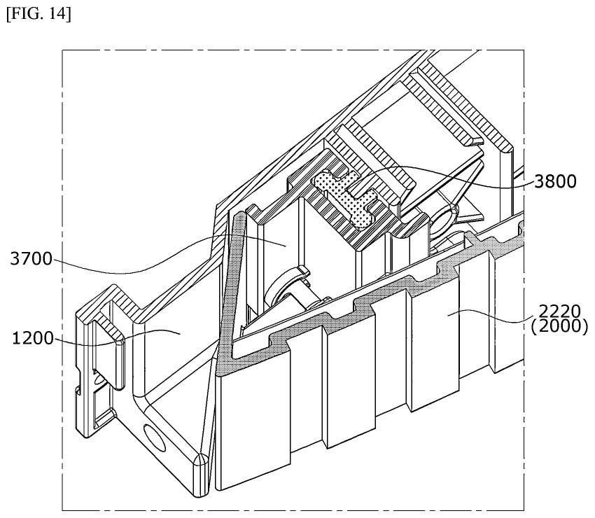

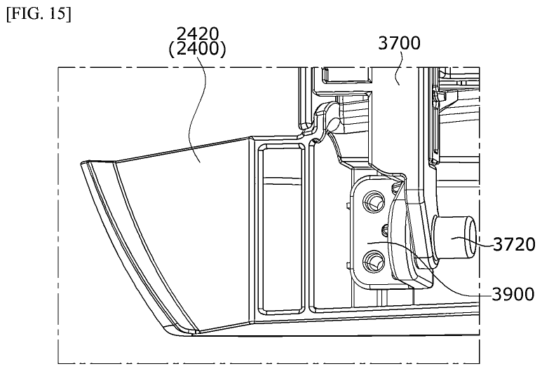

FIG. 14 is a view illustrating a state in which the side plate and the rail block are disposed, and FIG. 15 is a view illustrating a state in which the connecting bracket connects the second skirt and the side plate.

Referring to FIGS. 2, 5, and 14, the side plate 3700 may be fixedly installed in the first skirt 2200. The side plate 3700 may be disposed in the first skirt 2200 in the height direction. The side plate 3700 may be provided as a plurality of side plates 3700. The plurality of side plates 3700 may be disposed to be spaced apart from each other in the width direction. A rail groove which may accommodate the rail block 3800 therein may be formed in the side plate 3700.

The side plate 3700 may include a central protrusion 3720. As illustrated in FIG. 5, the central protrusion 3720 may protrude from the side plate 3700 and rotatably support the second skirt 2400. The central protrusion 3720 is a rotation center of the second skirt 2400, and when the second skirt 2400 is moved by the second support block 3440 of the support unit 3400, the second skirt 2400 may be rotated around the central protrusion 3720, which is the rotation center, to be tilted.

Referring to FIGS. 2, 5, and 14, the rail block 3800 may be fixedly installed in the first housing 1200 of the housing unit 1000. The rail block 3800 may be disposed in the rail groove formed in the side plate 3700 in a state of being coupled to the first housing 1200. In this case, the rail block 3800 may be disposed in the height direction. The rail block 3800 may slidably support the side plate 3700.

Referring to FIGS. 2 and 15, the connecting bracket 3900 may be disposed in the second skirt 2400. The connecting bracket 3900 may have a “ [symbol] ” shape. The connecting bracket 3900 may connect the second skirt 2400 and the side plate 3700. That is, the second skirt 2400 may be supported by the connecting bracket 3900 coupled to the side plate 3700. In addition, since the connecting bracket 3900 is coupled to the second skirt 2400, the second skirt 2400 may rotate around the central protrusion 3720 of the side plate 3700 along with the connecting bracket 3900.

Hereinafter, a process of operating the vehicle air skirt apparatus 1 will be described.

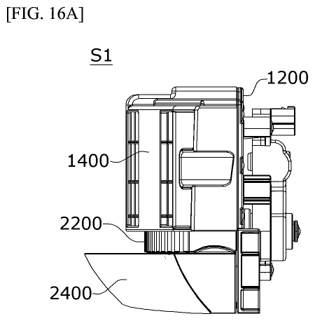

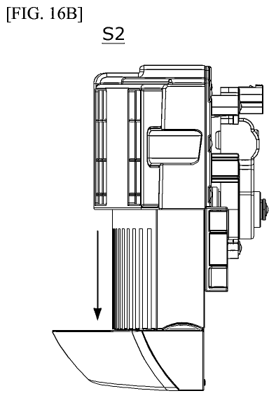

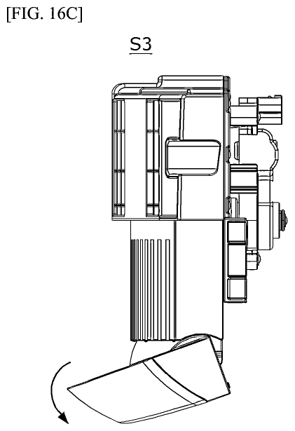

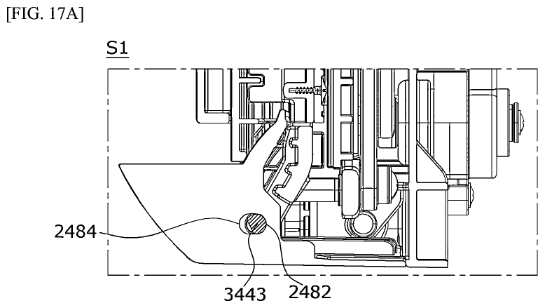

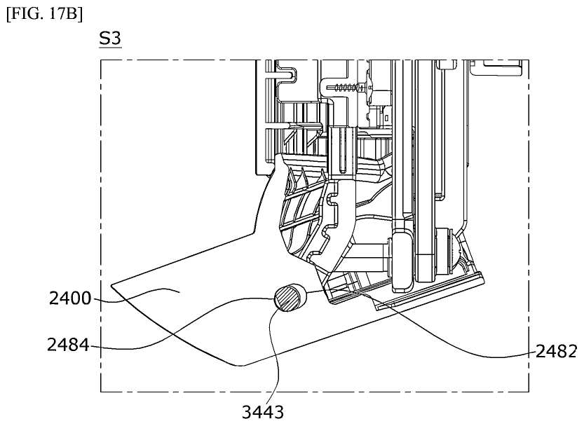

FIG. 16A shows the first state of the vehicle air skirt apparatus according to one embodiment of the present invention, FIG. 16B shows the second state of the vehicle air skirt apparatus according to one embodiment of the present invention, FIG. 16C shows the third state of the vehicle air skirt apparatus according to one embodiment of the present invention, FIG. 17A shows shapes of states in which the support protrusion of the second support block of the support unit is in contact with a first region of a first slit hole of the second skirt and FIG. 17B shows shapes of states in which the support protrusion of the second support block of the support unit is in contact with a second region of a first slit hole of the second skirt.

Referring to FIGS. 1 to 16C, more specifically, in the first state S1 of the vehicle air skirt apparatus 1 shown in FIG. 16A,, the first skirt 2200 maintains a state of not moving toward the outside of the housing unit 1000 through the withdrawal hole 1000a of the housing unit 1000. In this case, an end portion of the first skirt 2200 in the height direction is exposed to the outside of the second housing 1400. In addition, as illustrated in FIG. 11, in the first state S1, the fourth accommodation groove 3543 of the second auxiliary plate 3540 is disposed at a position at which the fourth accommodation groove 3543 does not communicate with the second accommodation groove 3523 of the first auxiliary plate 3520.

In this state, when power is generated by the actuator 3100, the first link 3220 connected to the actuator 3100 is rotated, and the second link 3240 connected to the first link 3220 is rotated to press the first support block 3420 of the support unit 3400 as if pulling the first support block 3420 downward in the height direction. Accordingly, the first support block 3420 moves downward in the height direction. In this case, since rotation of the stopper 3600 is blocked by the first auxiliary plate 3520, the second support block 3440, the second auxiliary plate 3540, and the stopper 3600 move downward like the process from FIG. 11 to FIG. 12.

In addition, since the rail block 3800 is fixedly installed in the first housing 1200, the side plate 3700 is guided and moved by the rail block 3800. Accordingly, the first skirt 2200 coupled to the side plate 3700 moves downward along with the side plate 3700 in the height direction, and the slide cover 3300 also moves downward along with the first skirt 2200. In addition, the second skirt 2400 connected to the side plate 3700 through the connecting bracket 3900 also moves downward along with the side plate 3700 and the connecting bracket 3900 in the height direction. Accordingly, a state of the vehicle air skirt apparatus 1 is changed from the first state S1 to the second state S2.

In the second state S2 of the vehicle air skirt apparatus shown in FIG. 16B, the first skirt 2200 and the second skirt 2400 moves downward in the height direction from the first state S1. In this state, when power is continuously generated by the actuator 3100, the link unit 3200 is continuously rotated. Accordingly, since the support unit 3400 is pressed downward in the height direction by the link unit 3200, the first moving part 3441 of the second support block 3440 of the support unit 3400 presses the stopper 3600.

In this case, as illustrated in FIG. 12, since the fourth accommodation groove 3543 of the second auxiliary plate 3540 is disposed at a position at which the fourth accommodation groove 3543 communicates with the second accommodation groove 3523 of the first auxiliary plate 3520, when the first moving part 3441 of the second support block 3440 presses the stopper 3600, the stopper 3600 may be rotated in place and rotated toward the second accommodation groove 3523 of the first auxiliary plate 3520 and disposed in the second accommodation groove 3523. Accordingly, as illustrated in FIG. 13, the moving path of the first moving part 3441 of the second support block 3440 may be activated.

In a state in which the moving path of the first moving part 3441 is activated, since the support unit 3400 is moved downward by the link unit 3200, the first moving part 3441 of the second support block 3440 may move from the third region 3341 to the fourth region 3342 of the third slit hole 3340 of the slide cover 3300 as illustrated in FIG. 16B. Accordingly, further movement of the second support block 3440 is blocked.

As described above, in a process in which movement of the second support block 3440 is blocked, the second moving part 3442 of the second support block 3440 moves the second skirt 2400 downward further from a level in the second state S2. Since the connecting bracket 3900 is rotatably connected to the side plate 3700, the second skirt 2400 connected to the connecting bracket 3900 is rotated around the central protrusion 3720 of the side plate 3700 along with the connecting bracket 3900. Accordingly, the second skirt 2400 is tilted from the second state S2, and the vehicle air skirt apparatus 1 enters a third state S3.

Referring to FIGS. 17A and 17B, in a process in which the second skirt 2400 is tilted, like a process from FIG. 17A to 17B, the first slit hole 2480 may come into contact with the support protrusion 3443 of the second support block 3440 in a sequence from the first region 2482 to the second region 2484. Accordingly, further rotation of the second skirt 2400 is blocked, and thus the tilting of the second skirt 2400 is stopped.

As described above, a state of the vehicle air skirt apparatus 1 according to one embodiment of the present invention may be changed from the first state S1 to the third state S3 to expand a range in which a headwind is blocked. Accordingly, since the headwind is effectively blocked by the vehicle air skirt apparatus 1, components in the vehicle can be prevented from unintended supercooling, and a probability that foreign matter present on a road surface collides with the components in the vehicle can be reduced.

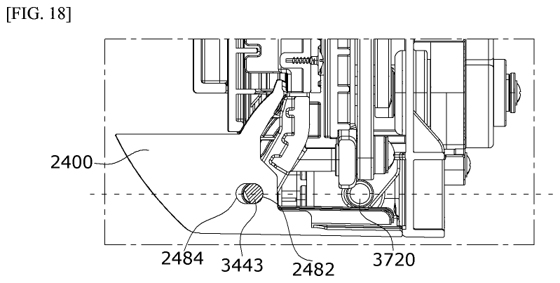

FIG. 18 is a view illustrating an arrangement relationship between the support protrusion of the second support block of the support unit and the central protrusion of the side plate.

Referring to FIG. 18, the second moving part 3442 of the second support block 3440 may be disposed to be inclined with respect to the first moving part 3441. More specifically, the second moving part 3442 may be disposed to be gradually inclined toward the front of the first moving part 3441 in the longitudinal direction. This is to secure a distance between the central protrusion 3720 of the side plate 3700 and the support protrusion 3443 of the second support block 3440 of the support unit 3400 disposed in the first slit hole 2480 of the second skirt 2400. Accordingly, after the second skirt 2400 is rotated to be tilted, the occurrence of additional movement can be suppressed. Accordingly, since the shake is prevented after the second skirt 2400 is tilted, the stability of the second skirt 2400 can be improved.

In addition, referring to FIG. 18, the rotation center of the second skirt 2400 may be collinearly disposed with the support protrusion 3443 of the second support block 3440 in a direction from the first support block 3420 of the support unit 3400 toward the second support block 3440. More specifically, the support protrusion 3443 of the second support block 3440 may be collinearly disposed with the central protrusion 3720 of the side plate 3700 in the longitudinal direction.

Since a support protrusion 3443 of a second support block 3440 of the conventional air skirt apparatus is disposed at a higher level than a center of a central protrusion 3720 of a side plate 3700, the support protrusion 3443 in a first state S1 comes into contact with a second region 2484 of a first slit hole 2480, and in a third state S3 in which the tilting is completed, the support protrusion 3443 comes into contact with a first region 2482 of the first slit hole 2480. Accordingly, in the third state S3, a phenomenon in which a conventional second skirt 2400 is moved toward the second region 2484 of the first slit hole 2480 by a headwind or vibrations generated during traveling of a vehicle can occur.

Accordingly, the structure of the present invention in which the support protrusion 3443 and the central protrusion 3720 are collinearly disposed can prevent a phenomenon in which the second skirt 2400 in the third state S3 is moved in the first slit hole 2480 by a headwind or vibrations generated during the traveling of the vehicle.

In addition, the structure of the present invention in which the support protrusion 3443 and the central protrusion 3720 are collinearly disposed can prevent the support protrusion 3443 of the second support block 3440 in the first state S1 from excessively supporting the second skirt 2400. In addition, in such a structure, the support protrusion 3443 of the second support block 3440 can stably support the second skirt 2400 which is sagged in a direction of gravity after the second skirt 2400 is tilted as in FIG. 17B.

According to one embodiment of the present invention, since the formation of a gap between a second skirt and an operation control unit after the second skirt rotates is prevented, the stability and headwind blocking performance of the second skirt can be maintained.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to the modifications and changes fall within the scope of the present invention defined by the appended claims.

What is claimed is:

1. A vehicle air skirt apparatus comprising:
a housing unit in which a withdrawal hole is formed;
a skirt unit including a first skirt which is movably disposed in the housing unit and allowed to protrude outward from the housing unit through the withdrawal hole and a second skirt which is rotatable to be tilted after the first skirt is completely withdrawn; and
a support unit configured to move in the same direction as a moving direction of the first skirt and rotatably support the second skirt tilted after the first skirt is completely withdrawn.

2. The vehicle air skirt apparatus of claim 1, comprising a slide cover fixedly installed on the first skirt, wherein the support unit is slidably disposed on the slide cover.

3. The vehicle air skirt apparatus of claim 2, comprising a link unit configured to be connected to the support unit and move the support unit,
wherein the support unit includes:
a first support block connected to the link unit; and
a second support block connected to the first support block and movably disposed on the slide cover.

4. The vehicle air skirt apparatus of claim 3, wherein the second support block of the support unit includes:
a first moving part disposed inside the slide cover;
a second moving part disposed on an end portion of the first moving part and disposed outside the slide cover; and
a support protrusion configured to be disposed on the second moving part and movably support the second skirt.

5. The vehicle air skirt apparatus of claim 4, wherein the second moving part of the second support block is disposed to be inclined with respect to the first moving part.

6. The vehicle air skirt apparatus of claim 4, wherein the second skirt includes:
a skirt body;
a center rib configured to support the skirt body;
a side rib disposed outside the center rib and configured to support the skirt body; and
a slit hole formed in the center rib and configured to accommodate the support protrusion of the second moving part of the support unit therein.

7. The vehicle air skirt apparatus of claim 6, wherein the slit hole of the second skirt includes:
a first region configured to come into contact with the support protrusion before the second skirt is tilted; and
a second region configured to come into contact with the support protrusion after the second skirt is tilted.

8. The vehicle air skirt apparatus of claim 4, comprising a stopper rotatably coupled to the slide cover in place and configured to come into contact with the first moving part of the second support block of the support unit.

9. The vehicle air skirt apparatus of claim 8, wherein the stopper is pressed by the second support block of the support unit that moves in conjunction with movement of the link unit to activate a moving path of the first moving part.

10. The vehicle air skirt apparatus of claim 4, comprising a side plate fixedly installed on the first skirt and configured to provide a protrusion as a rotation center of the second skirt,
wherein the rotation center of the second skirt is collinearly disposed with the support protrusion of the second support block in a direction from the first support block of the support unit toward the second support block.
